(19) United States
(12) Patent Application Publication
(10) Pub. No.: US 2014/0011930 A1
(43) Pub. Date: Jan. 9, 2014

(54) Bio-Renewable Carboxylic Acid Esters and Mixtures Thereof Useful as Plasticizers

(71) Applicants: John A. Buono, Riverside, RI (US); Robert S. Brookman, Providence, RI (US); Jared W. Kostka, Pawtucket, RI (US); Nicole M. Marshall, Barrington, RI (US)

(72) Inventors: John A. Buono, Riverside, RI (US); Robert S. Brookman, Providence, RI (US); Jared W. Kostka, Pawtucket, RI (US); Nicole M. Marshall, Barrington, RI (US)

(73) Assignee: TEKNOR APEX COMPANY, Pawtucket, RI (US)

(21) Appl. No.: 13/542,054

(22) Filed: Jul. 5, 2012

(51) Int. Cl. C08K 5/11; C08L 27/06; C08K 5/1515

(52) U.S. Cl. 524/311; 106/505; 106/504

(57) ABSTRACT

Novel carboxylic acid polyesters, and mixtures thereof, are useful as plasticizers such as for polyvinylchloride compositions. These polyesters and the other components of the mixtures are prepared from bio-renewable sources.

### FIELD OF INVENTION

The present invention relates to novel carboxylic acid polyesters, and mixtures thereof, useful as plasticizers such as for polyvinylchloride compositions. These polyesters and the other components of the mixtures are prepared from bio-renewable sources.

### BACKGROUND OF THE INVENTION

Flexible polyvinyl chloride (PVC) compounds are highly varied, and can generally be described as either as a general purpose compound, or a high performance compound. For general purpose PVC compositions, a plasticizer that exhibits good overall properties is required such as efficiency, tensile strength, thermal stability, and compatibility. The industry standard for such a plasticizer is di-(2-ethylhexyl) phthalate (DEHP).

U.S. Pat. No. 4,130,532 relates to caprolactone modified polyesters derived from an aliphatic dihydroxy compound and a mixture of aliphatic dicarboxylic acids and a proportion above 10 mol % of the total acids used, of an aromatic dicarboxylic acid and terminated with an alcohol or monocarboxylic acid such that the molecular weight ranges from 500 to 1400, and can be used as plasticizers.

U.S. Pat. No. 4,133,794 relates to caprolactone modified polyesters, derived from an aliphatic diol, an aliphatic dicarboxylic acid or mixtures thereof, optionally with a proportion not exceeding 10 mole % of an aromatic dicarboxylic acid and terminated with an alcohol or monocarboxylic acid, that can be used as plasticizers.

U.S. Pat. No. 8,158,731 relates to polymer blends comprising a biopolymer and a substituted or unsubstituted aliphatic polyester. The aliphatic polyester comprises repeating units derivable from a substituted or unsubstituted aliphatic diacid, repeating units derivable from a substituted or unsubstituted aliphatic diol, and one or two terminator units derivable from a substituted or unsubstituted aliphatic alcohol.

### SUMMARY OF THE INVENTION

The present invention relates to blends of carboxylic acid polyesters that impart good overall performance characteristics to polymers such as PVC when compared to existing performance plasticizers such as di-(2-ethylhexyl) phthalate. Improved properties generally include lower brittle point temperatures and improved dynamic heat stability.

The major component of the synthesis of polyesters of the present invention is a low molecular weight polyester derived from carboxylic acids and diols that are capped with a monoalcohol and blended with a synthesized byproduct diester. The yield of these two components with respect to all of the different types of polyesters produced by the synthesis is very high.

A polyester composition free of a biopolymer is disclosed and comprises a blend of a carboxylic acid polyester having the formula:

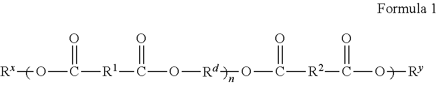

wherein R^{x} and R^{y}, independently, are derived from a monohydric alcohol having from about 4 to about 9 carbon atoms, wherein each R^{d}, independently, is a aliphatic group having from 2 to about 6 carbon atoms, wherein each R¹, independently, is an aliphatic group having from 0 to about 4 carbon atoms, wherein R² is an aliphatic group having from 0 to about 4 carbon atoms, and wherein n is an integer of from 1 to 3; and

a diester having the formula:

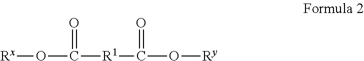

wherein R^{x} and R^{y}, independently, are derived from a monohydric alcohol having from about 4 to about 9 carbon atoms, and wherein R¹ is an aliphatic having from 0 to 4 carbon atoms; and wherein the mole amount of Formula 1 is at least 50% and the mole amount of Formula 2 is at least 8% based upon the total moles of all products produced by the synthesis of said Formula 1 product.

### DETAILED DESCRIPTION OF THE INVENTION

The polyesters of the present invention are synthesized from dicarboxylic acids, diols, and monoalcohols and result in the formation of generally a major amount of a low molecular weight polyester that can have 3 or less repeat units and a minor amount of a diester. These two types of polyesters comprise a blend that is useful as plasticizers for various polymers and especially polyvinyl chloride.

The major component of the blend, i.e. the low molecular weight polyester is represented by Formula 1

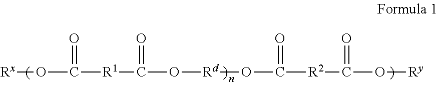

wherein R^{x} and R^{y}, independently, are derived from a monohydric alcohol having a total of from about 4 to about 9 carbon atoms. The alcohol has an alkyl group that can be linear or branched and preferably has from 6 to 9 carbon atoms. Specific examples of such alcohols include octyl alcohol, iso-hexyl alcohol, 2-ethylhexyl alcohol, and isononyl. Linear butanol and linear hexanol are desired with n-octyl being preferred. The various monoalcohols are readily available from bio-renewal sources known to the literature and to the art. The one or more diols of Formula 1, i.e. Rd, independently, is an aliphatic having a total of from 2 to about 6 carbon atoms with from about 2 to about 4 carbon atoms being preferred such as ethylene glycol, 1,3-propane diol, and butane diol. Preferably the alkyl group of the diol can either be linear or branched. The diols are readily available from bio-renewal sources. The R¹ group of the dicarboxylic acid is an aliphatic having from 0, i.e. oxalic acid up to about 4 carbon atoms, i.e. adipic acid. Other such acids include malonic acid, succinic acid, and glutaric acid. Generally adipic and glutaric are desired with succinic acid being preferred. All such dicarboxylic acid are readily obtained from natural sources, i.e. bio-newable feedstocks. R² of the dicarboxylic acid also is an aliphatic that can have from 0 to about 4 carbon atoms and can be the same compounds as R¹ and thus is hereby fully incorporated by reference. In preparing the major component of the polyester blend of the present invention, R², independently, can be the same as R¹, or different. Moreover, since n is an integer of either 1, or 2, or 3, more than one type of R¹ dicarboxylic acid can be utilized to form the left component of Formula 1. While the right side component of Formula 1, i.e. R² only has one R² compound therein, different dicarboxylic acids can be utilized to form the R² component of either polyester molecules. Similarly, more than one diol can be utilized to form the major polyester component of the present invention and hence R^{d} can vary from molecule to molecule. Common alcohols would include iso-hexyl alcohol, 2-ethylhexyl alcohol, iso-nonyl alcohol, and linear alcohols such as n-butanol, n-hexanol and n-octanol. Any of the common diols would include ethylene glycol, propylene glycol, 1,4-butanediol and 1,3-propanediol.

Since n of Formula 1 is generally 3 or less, the molecular weight of the polyester of Formula 1 is relatively low. That is, the weight average molecular weight of Formula 1 is generally from about 450 to about 1050, desirably from about 450 to about 850, and preferably from about 450 to about 650.

The minor synthesized product, i.e. the diester, generally has the following formula:

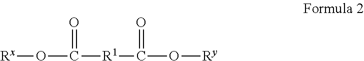

wherein R^{x} and R^{y}, independently, are derived from a monohydric alcohol having from 4 to about 8 carbon atoms and preferably wherein the alkyl group can be linear or branched and is from 6 to about 9 carbon atoms with n-octyl alcohol being preferred. R¹ of the dicarboxylic acid group generally has from 0 to about 4 carbon atoms. Thus, the reacted dicarboxylic acid can be oxalic, malonic, succinic, glutaric, or adipic acid. Generally, adipic acid and glutaric acid are desired, and succinic acid is preferred.

An important aspect of the present invention is to achieve high yields synthesized from the starting compounds, of the monoalcohol, the dicarboxylic acid, and a diol. The mole ratios of such compounds are generally whole numbers. In order that the monoalcohols can end cap the polyester, the end group of the polyester before reaction with the alcohol is an ester group, and not a diol group. Accordingly, the mole amount of the diols is generally one less than that of the mole amount of the dicarboxylic acids. Since n is an integer of either 1, or 2, or 3, the mole ratio of the dicarboxylic acid to the diol is generally 4:3 or 3:2, or preferably 2:1. The mole amount of the monoalcohol is always 2 so that it can end cap the polyester. While desirably the mole ratios are whole integers as indicated, slight variations thereof are suitable. For example, with respect to each mole amount, the actual amount utilized can vary plus or minus one fourth (i.e. ±0.25 and desirably ±0.10). For example, if n is 3, the amount thereof can range from about 2.75 to about 3.25. Similarly, if the amount is 2, the mole ratio thereof can range from about 1.75 to about 2.25.

When polymers of Formulas 1 and 2 are synthesized according to the present invention wherein the ratio of diacid to diol to monoalcohol is 4:3:2, the yield of the Formula 1 polymer is generally at least about 50%, desirably at least about 70%, and preferably at least about 90% based upon all the moles of the various components produced. The amount of the minor product or diester is generally less than about 50 mole %, desirably less than about 30 mole %, and preferably less than about 10 mole %. The remaining percentages relate to compounds or polymers other than Formulas 1 and 2.

When the mole ratio of diacids to diol to the monoalcohol is 3:2:2, the yield of the Formula 1 compound is at least about 50%, desirably at least about 60%, and preferably at least about 75%. The yield of the Formula 2 compounds is desirably less than about 50%, desirably less than about 40%, and preferably less than about 25%. Once again, the remaining mole percent relates to compounds or polymers produced other than that of Formulas 1 and 2. When the diacid to diol to monoalcohol ratio is 2:1:2, the amount of the Formula 1 polymer is at least about 50%, desirably at least about 60%, and preferably at least about 65%. The yield of the diester product of the Formula 2 compound is generally less than about 15%, desirably less than about 25%, and preferably less than about 30% with the difference being the other non-formula 1 or 2 compounds that are produced.

It is an important aspect of the present invention that lactones such as caprolactone or their precursors such as 6-hydroxycapronic acid not be utilized or if utilized are present in very small mole amounts in the synthesized polyester. That is, the amount of any lactone is generally about 1.0 mole % or less, desirably about 5 mole % or less, and preferably about 2 mole % or less and most preferably nil, that is non-existent.

The products of the present invention are produced according to processes well known to the art and to the literature. Generally, the diacids, the diols, and the monoalcohols are reacted in the presence of a catalyst at elevated temperature with concurrent removal of the water formed during the reaction. The temperature of the reaction is between about 175° C. to about 240° C. and preferably between about 200° C. to about 220° C. Catalysts include those generally accepted in the industry, for example tetra-alkyl titanates such a tetra-n-butyl titanate or tetra-iso-propyl titanate, and mixtures thereof, dibutyl tin oxide, monobutyl tin oxide, tin oxalate, di-n-octyl tin oxide, n-propyl zirconate, and titanate chelates such a titanium acetyl acetonate.

The polyester blends of the present invention are well suited for use as plasticizers with regard to various polymers such as polyvinyl chloride and copolymers of vinyl chloride with vinyl acetate, acrylates, and methacrylates. They are also suited for use in PVC plastisol formulations.

The polyester blends of the present invention can also be utilized with other plasticizers such as various epoxidized seed oils such as, linseed oil, tall oil, and most preferably epoxidized soybean oil to provide a plasticizer with improved compatibility in PVC compounds. Such epoxidized oils also provide improved or lower viscosity of the PVC compound and also lower the cost thereof.

Through careful selection of the alcohol, dicarboxylic acid, and diol it is possible to produce a product that is totally derived from bio-renewable sources.

The following examples serve to illustrate the present invention but to limit the same.

### Example 1

| Monoalcohol | C8 (n-octanol) |
|---|---|
| Diacid | C4 (succinic acid) |
| Diol | C3 (1,3 propanediol) |
| n | 1 |
| d | 1 |

The Example 1 formulation gives a 2:1:2 molar ratio of succinic acid:1,3 propanediol:n-octanol.

Into a 2 liter, four neck, round bottom reaction flask equipped with a stirrer, digital temperature controller, nitrogen purge, and a condenser with a Dean Stark trap was charged 472 grams of succinic acid, 163 grams of 1,3 propanediol and 520 grams of n-octanol. The reaction was slowly heated to 140° C. and 0.29 grams of catalyst was added. The temperature was increased to 220° C. and the heating was continued for six hours until the acid value reached 0.34 milligrams of KOH/gram of product, and 143 milliliters of water had been collected. The product was steam distilled at 170° C. using 65 milliliters of water, cooled to 80° C., and treated with a solution of 0.24 grams of sodium hydroxide dissolved in 75 milliliters of water. The product was dried under vacuum, treated with carbon and magnesium silicate and filtered. The yield was 966 grams or 96% of the theoretical yield. The product so obtained was a mixture, consisting of 68% of the 2:1:2 molar ratio product of Formula 1 and 32% of the di-ester product of Formula 2.

### Example 2

| Monoalcohol | C8 (n-octanol) |
|---|---|
| Diacid | C4 (succinic acid) |
| Diol | C3 (1,3 propanediol) |
| n | 3 |
| d | 3 |

The Example 2 formulation gives a 4:3:2 molar ratio of succinic acid:1,3 propanediol:n-octanol.

Example 2 was polymerized as follows:
Batch temperature was set at 170° C.
140° C. added 0.29 g DBTO catalyst and heated one hour at 170° C.
Increased temperature to 220° C.
The heat was shut down when the acid value reached 0.34 mg KOH/g. 172 ml H2O was collected. The reaction was complete in 9 hours.
Acid value was 2.2 mg KOH/g.
The temperature was set to 170° C. and a vacuum was applied for one hour.
Cooled at 80° C.
Filtered through 50 g celite using a vacuum.
Yield was 976 g (99% of theoretical).

The product so obtained was a mixture consisting of 90% of the 4:3:2 molar ratio product of Formula 1 and 10% of the diester product of Formula 2.

This plasticizer was evaluated in the same formulations as test compounds 1, 2, 3 along with DEHP and Example 1. The Loop Spew test showed that the plasticizer of Example 2 failed compatibility testing in the lower gauge formulations.

### Loop Spew Results

| | DEHP | Example 1 | Example 2 |
|---|---|---|---|
| 80-85 C Gauge | None | Very Slight | None |
| 81-85 A Gauge | None | Very Slight | Moderate-Heavy |
| 59-67 A Gauge | None | Very Slight | Heavy |

Following the process described in Example 1, a product with a higher molecular weight was similarly prepared. The product so obtained was a mixture consisting of 90% of a 4:3:2 molar ratio product of Formula 1 and 10% of the di-ester product of Formula 2.

Evaluation:

PVC compounds were prepared with the plasticizers described in Example 1 and Example 2, and a commercial sample of DEHP, containing standard heat stabilizers, antioxidant and a lubricant. The compounds were evaluated in standard laboratory tests according the following ASTM methods:

| Test | ASTM Method |
|---|---|
| Specific Gravity | D-792 |
| Hardness | D-2240 |
| Tensile (psi) | D-638 |
| Brittle Point ° C. | D-746 |
| Oven Stability (210° C.) | D-1203 |
| Dynamic Heat Stability | D-2538 |
| Loop Spew | D-3291 |
| % Volatile Loss | D-1203 |

The PVC compounds tested are typical PVC compounds well known in the industry. The compositions of the PVC compounds generally consist of, but are not limited to a

a. Polyvinyl chloride resin

b. Plasticizer

c. Antioxidant

d. Heat stabilizer

e. Co-stabilizers

f. Lubricant

g. UV absorber

h. Inorganic filler

i. Flame retardants

These additives may include but are not limited to

Plasticizers that include adipate, trimelletitate and the most widely used phthalate esters;

Antioxidants that include substituted hindered phenols, organophosphites, or thioesters;

Heat stabilizers include complex mixtures of metal soaps, with the metal cations most commonly being barium, calcium or zinc;

Co-stablizers include any of the expoxidzed vegetable oils such as epoxidized soybean oil;

Lubricants that include fatty acids, and their amides, esters or salts, polyethylene waxes;

UV absorbers include benzotriazoles, hindered amines

Inorganic fillers that include calcium carbonate, talc, clay, inorganic pigments; and

Flame retardants that include halogenated plasticizers, phosphate esters, brominated aromatic compounds, inorganic hydroxides such a magnesium hydroxide, talcs

### PVC Test Compound 80-85 C Gauge Composition

| Raw Material (parts) | DEHP | Example 1 |
|---|---|---|
| PVC Resin | 100.00 | 100.0 |
| Epoxidized Soybean Oil | 10.00 | 10.00 |
| Plasticizer | 23.00 | 20.50 |
| Phosphite Co-Stabilizer | 0.50 | 0.50 |
| Ca/Zn Heat Stabilizer | 0.25 | 0.25 |
| Stearic Acid | 0.05 | 0.05 |

### PVC Test Compound 80-85 C Gauge Properties

| Property | DEHP | Example 1 |
|---|---|---|
| Specific Gravity | 1.28 | 1.29 |
| Hardness | | |
| Shore C (instant) | 93 | 89 |
| Shore C (10 sec delay) | 85 | 82 |
| Tensile (psi) | 3840 | 4207 |
| 100% Modulus | 3440 | 3501 |
| % Elongation | 281 | 290 |
| Brittle Point ° C. | −17.0 | −25.5 |
| Oven Stability (210° C.) | | |
| Initial Color | Clear | Clear |
| Initial Color Failure (min) | 15 | 15 |
| Decomposition Failure (min) | 50 | 50 |
| Dynamic Heat Stability | 19 | 18 |
| (min) | | |
| Loop Spew | None | Very Slight |
| % Volatile Loss | 1.56 | 2.55 |

The data shows that all of the properties of the plasticizer of Example 1 of the invention are comparable to the industry standard. However it has significant advantages in brittle point and more significantly efficiency since 10% less plasticizer is required to obtain the same level of hardness as DEHP.

### PVC Test Compound 81-85 A Gauge Composition

| Raw Material (parts) | DEHP | Example 1 | Example 2 |
|---|---|---|---|
| PVC Resin | 100.00 | 100.0 | 100.0 |
| Epoxidized Soybean Oil | 10.00 | 10.00 | 10.0 |
| Plasticizer | 46.00 | 43.70 | 43.70 |
| Phosphite Co-Stabilizer | 0.50 | 0.50 | 0.50 |
| Ca/Zn Heat Stabilizer | 0.25 | 0.25 | 0.25 |
| Stearic Acid | 0.05 | 0.05 | 0.05 |

### PVC Test Compound 81-85 A Gauge Properties

| Property | DEHP | Example 1 | Example 2 |
|---|---|---|---|
| Specific Gravity | 1.23 | 1.24 | 1.28 |
| Hardness | | | |
| Shore C (instant) | 90 | 88 | 92 |
| Shore C (10 sec delay) | 83 | 82 | 85 |
| Tensile (psi) | 2875 | 2915 | |
| 100% Modulus | 1490 | 1304 | |
| % Elongation | 380 | 423 | |
| Brittle Point ° C. | −34.5 | −48.5 | |
| Oven Stability (210° C.) | | | |
| Initial Color | Clear | Clear | |
| Initial Color Failure (min) | 15 | 15 | |
| Decomposition Failure (min) | 50 | 50 | |
| Dynamic Heat Stability | 40 | 44 | |
| (min) | | | |
| Loop Spew | None | Very Slight | Moderate- |
| | | | Heavy |
| % Volatile Loss | 2.73 | 5.23 | |

Again the data shows that all of the properties of the plasticizer of Example 1 are comparable to the industry standard. However it has significant advantages in brittle point. Furthermore the properties for Example 2 could not be measured due to the poor performance of this higher molecular weight plasticizer in the loop spew test showing that this plasticizer is incompatible in PVC compounds.

### PVC Test Compound 59-67 A Gauge Composition

| Raw Material (parts) | DEHP | Example 1 | Example 2 |
|---|---|---|---|
| PVC Resin | 100.00 | 100.0 | 100.0 |
| Epoxidized Soybean Oil | 10.00 | 10.00 | 10.00 |
| Plasticizer | 91.00 | 86.45 | 86.45 |
| Phosphite Co-Stabilizer | 0.50 | 0.50 | 0.50 |
| Ca/Zn Heat Stabilizer | 0.25 | 0.25 | 0.25 |
| Stearic Acid | 0.05 | 0.05 | 0.05 |

### PVC Test Compound 59-67 A Gauge Properties

| Property | DEHP | Example 1 | Example 2 |
|---|---|---|---|
| Specific Gravity | 1.16 | 1.18 | 1.24 |
| Hardness | | | |
| Shore A (instant) | 68 | 69 | 74 |
| Shore A (15 sec delay) | 60 | 62 | 67 |
| Tensile (psi) | 1559 | 1656 | |
| 100% Modulus | 554 | 559 | |
| % Elongation | 439 | 451 | |
| Brittle Point ° C. | −48.5 | <−60.0 | |
| Oven Stability (210° C.) | | | |
| Initial Color | Clear | Clear | |
| Initial Color Failure (min) | 15 | 15 | |
| Decomposition Failure (min) | 50 | 60 | |
| Dynamic Heat Stability | 72 | 85 | |
| (min) | | | |
| Loop Spew | None | Very Slight | Heavy/tacky |
| % Volatile Loss | 3.54 | 7.55 | |

Again the data shows that all of the properties of the plasticizer of Example 1 are comparable to the industry standard. However it has significant advantages in brittle point and more significantly efficiency since 13% less plasticizer is required to obtain the same level of hardness as DEHP. Furthermore the properties for Example 2 could not be measured due to the poor performance of this higher molecular weight plasticizer in the loop spew test showing that this plasticizer is incompatible, in PVC compounds.

Example 1/Epoxidized Soybean Oil Mixture

A 50% by weight blend of the ester mixture from Example 1 was blended with 50% of epoxidized soybean oil (ESO) and evaluated in a PVC compound.

### PVC Test Compound 80-85 C Gauge Composition

| Raw Material (parts) | DEHP | Example 1/ESO |
|---|---|---|
| PVC Resin | 100.00 | 100.0 |
| Epoxidized Soybean Oil | 10.00 | |
| Plasticizer | 23.00 | 33.23 |
| Phosphite Co-Stabilizer | 0.50 | 0.50 |
| Ca/Zn Heat Stabilizer | 0.25 | 0.25 |
| Stearic Acid | 0.05 | 0.05 |

### PVC Test Compound 80-85 C Gauge Properties

| Property | DEHP | Example 1/ESO |
|---|---|---|
| Specific Gravity | 1.28 | 1.29 |
| Hardness | | |
| Shore C (instant) | 90 | 85 |
| Shore C (10 sec delay) | 85 | 79 |
| Tensile (psi) | 4083 | 3759 |
| 100% Modulus | 3617 | 2957 |
| % Elongation | 282 | 352 |
| Brittle Point ° C. | −22 | −16.5 |
| Oven Stability (210° C.) | | |
| Initial Color | Clear | Clear |
| Initial Color Failure (min) | 10 | 10 |
| Decomposition Failure (min) | 50 | 70 |
| Dynamic Heat Stability | 7 | 7 |
| (min) | | |
| Loop Spew | None | None |
| % Volatile Loss | 1.67 | 1.95 |

Use of an epoxidized vegetable oil resulted in good properties as well as equal efficiency to DEHP.

### PVC Test Compound 59-67 A Gauge Composition

| Raw Material (parts) | DEHP | Example 1/ESO |
|---|---|---|
| PVC Resin | 100.00 | 100.0 |
| Epoxidized Soybean Oil | 10.00 | 0.00 |
| Plasticizer | 91.00 | 101.91 |
| Phosphite Co-Stabilizer | 0.50 | 0.50 |
| Ca/Zn Heat Stabilizer | 0.25 | 0.25 |
| Stearic Acid | 0.05 | 0.05 |

### PVC Test Compound 59-67 A Gauge Properties

| Property | DEHP | Example 1/ESO |
|---|---|---|
| Specific Gravity | 1.16 | 1.18 |
| Hardness | | |
| Shore A (instant) | 60 | 60 |
| Shore A (15 sec delay) | 56 | 56 |
| Tensile (psi) | 1564 | 1678 |
| 100% Modulus | 518 | 508 |
| % Elongation | 451 | 484 |
| Brittle Point ° C. | −50.5 | −56 |
| Oven Stability (210° C.) | | |
| Initial Color | Clear | Clear |
| Initial Color Failure (min) | 15 | 10 |
| Decomposition Failure (min) | 60 | >90 |
| Dynamic Heat Stability | 54 | >120 |
| Loop Spew | None | Very Slight |
| % Volatile Loss | 4.58 | 5.05 |

Additional advantages of the compounds of the invention are their low cytotoxicity and resistance to gamma radiation especially when compared to the industry standard of di-2-ethylhexyl phthalate (DEHP). Gamma radiation stability is important since it allows for the convenient sterilization of articles prepared from PVC compound. The key performance standard is non-yellowing of the PVC compound after exposure to gamma radiation. An example of the improvement in gamma stability is shown below.

### PVC Test Compound-Gamma Irradiation Stability-A

| | DEHP | Example 1 |
|---|---|---|
| Raw Material (parts) | | |
| PVC Resin | 100.00 | 100.00 |
| Epoxidizied Soybean Oil | 12.00 | 12.00 |
| Plasticizer | 38.00 | 37.20 |
| Stearic Acid | 0.20 | 0.20 |
| Zinc Stearate | 0.25 | 0.25 |
| Colorant A | 0.06 | 0.06 |
| Colorant B | 0.09 | 0.09 |
| Property | | |
| Specific Gravity | 1.24 | 1.25 |
| Hardness | | |
| Shore A (instant) | 91 | 90 |
| Shore A (15 sec delay) | 86 | 84 |
| Cytotoxicity | | |
| Grade of cell lysis (0-none, <2 | 0 | 0 |
| pass, 4 = severe) | | |
| Gamma Radiation = 35 | | |
| kGys (3.5 Mrads) | | |
| Absolute YI | | |
| Original | 6.78 | 6.12 |
| After 35 kGys Gamma | 12.24 | 8.01 |
| After 35 kGys Gamma and Oven | 17.58 | 10.94 |
| Aging (48 hr. at 50° C.) | | |
| Change in YI from Original | | |
| After 35 kGys Gamma | 5.46 | 1.89 |
| After 35 kGys Gamma and Oven | 10.80 | 4.82 |
| Aging (48 hr. at 50° C.) | | |

In accordance with the patent statutes, the best mode and preferred embodiments have been set forth; the scope of the invention is not limited thereto, but rather by the scope of the attached claims.

What is claimed is:

1. A polyester composition free of a biopolymer, comprising:
a blend of a carboxylic acid polyester having the formula: 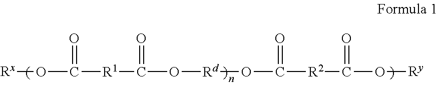
wherein R^{x} and R^{y}, independently, are derived from a monohydric alcohol having from about 4 to about 9 carbon atoms, wherein each R^{d}, independently, is an aliphatic group having from 2 to about 6 carbon atoms, wherein each R¹, independently, is an aliphatic group having from 0 to about 4 carbon atoms, wherein R² is an aliphatic group having from 0 to about 4 carbon atoms, and wherein n is an integer of from 1 to 3; and
a diester having the formula: 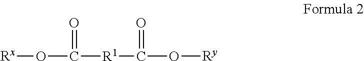
wherein R^{x} and R^{y}, independently, are derived from a monohydric alcohol having from about 4 to about 9 carbon atoms, and wherein R¹ is an aliphatic group having from 0 to 4 carbon atoms; and
wherein the mole amount of Formula 1 is at least 50% and the mole amount of Formula 2 is at least 8% based upon the total moles of all products produced by the synthesis of said Formula 1 product.

2. A polyester composition of claim 1, wherein Formula 1 R^{x} and R^{y}, independently, are an alkyl having from about 6 to about 9 carbon atoms, wherein each R^{d}, independently, in an alkyl diol having from 2 to about 6 carbon atoms, wherein each said R¹, independently, is an alkyl having from about, 0 to about 4 carbon atoms, wherein R² is an alkyl having from about 0 to about 4 carbon atoms, and
wherein said R^{x} and R^{y} of Formula 2, independently, are an alkyl alcohol having from about 6 to about 9 carbon atoms, and wherein said R¹ is an alkyl having from 0 to about 4.

3. The polyester composition of claim 2, wherein said R^{x} and said R^{y} are derived from n-octanol, iso-hexyl alcohol, 2-ethylhexyl alcohol, or isononyl alcohol, wherein said R^{d} is derived from propane diol, and wherein said R¹ and said R² is derived from succinic acid.

4. The polyester composition of claim 1, wherein the mole ratio of said dicarboxylic acid to said diol to said monoalcohol is about 3 to about 2 to about 2, and wherein the yield of said Formula 1 is at least about 60 mole % and wherein the yield of Formula 2 is less than about 40 mole % based upon the total number of moles of said polyester composition.

5. The polyester composition of claim 1, wherein the mole ratio of said dicarboxylic acid to said diol to said monoalcohol is about 2 to about 1 to about 2, and wherein the yield of said Formula 1 is at least about 60 mole % and wherein the yield of Formula 2 is less than about 25 mole % based upon the total number of moles of said polyester composition.

6. The polyester composition of claim 3, wherein the mole ratio of said dicarboxylic acid to said diol to said monoalcohol is about 2 to about 1 to about 2, and wherein the yield of said Formula 1 is at least about 60 mole %, wherein the yield of Formula 2 is less than about 25 mole % based upon the total number of moles of said polyester composition, and wherein said formula 1 has a weight average molecular weight of from about 450 to about 850.

7. The polyester composition of claim 1, including an epoxidized vegetable oil.

8. The polyester composition of claim 3, including an epoxidized vegetable oil.

9. The polyester composition of claim 4, including an epoxidized vegetable oil.

10. The polyester composition of claim 5, including an epoxidized soy bean oil.

11. The polyester composition of claim 6, including an epoxidized soy bean oil.

12. A polyvinyl chloride, vinyl chloride-vinyl acetate, vinyl chloride-acrylate, or a vinyl chloride-methacrylate composition comprising as a plasticizer the composition of claim 1.

13. A polyvinyl chloride, vinyl chloride-vinyl acetate, vinyl chloride-acrylate, or a vinyl chloride-methacrylate composition comprising as a plasticizer the composition of claim 3.

14. A polyvinyl chloride, vinyl chloride-vinyl acetate, vinyl chloride-acrylate, or a vinyl chloride-methacrylate composition comprising as a plasticizer the composition of claim 4.

15. A polyvinyl chloride composition comprising as a plasticizer the composition of claim 5.

16. A polyvinyl chloride composition comprising as a plasticizer the composition of claim 6.

17. A polyvinyl chloride composition comprising as a plasticizer the composition of claim 7.

18. A polyvinyl chloride composition comprising as a plasticizer the composition of claim 9.

19. A polyvinyl chloride composition comprising as a plasticizer the composition of claim 11.
